(19) United States
(12) Patent Application Publication
(10) Pub. No.: US 2014/0158740 A1
(43) Pub. Date: Jun. 12, 2014

(54) Fastening Tool

(71) Applicants: Kousuke Akutsu, Hitachinaka (JP); Shouichi Hirai, Hitachinaka (JP); Yoshiichi Komazaki, Hitachinaka (JP); Masaya Nagao, Hitachinaka (JP); Akiyuki Miyazaki, Hitachinaka (JP)

(72) Inventors: Kousuke Akutsu, Hitachinaka (JP); Shouichi Hirai, Hitachinaka (JP); Yoshiichi Komazaki, Hitachinaka (JP); Masaya Nagao, Hitachinaka (JP); Akiyuki Miyazaki, Hitachinaka (JP)

(73) Assignee: Hitachi Koki Co., Ltd., Tokyo (JP)

(21) Appl. No.: 14/130,562

(22) PCT Filed: Aug. 22, 2012
(86) PCT No.: PCT/JP2012/005245

§ 371 Date: Jan. 2, 2014

(30) Foreign Application Priority Data
Aug. 23, 2011 (JP) 2011-181232
Aug. 23, 2011 (JP) 2011-181258

(51) Int. Cl. B25C 1/04

(52) U.S. Cl. CPC B25C 1/04
USPC 227/130

(57) ABSTRACT

The fastening tool includes a housing, a trigger, a cylinder, a piston, and a main valve. The main valve allows a communication between the cylinder and the first air chamber in conjunction with an operation of the trigger. The housing is formed with a first air chamber, a second air chamber, and a third air chamber. The second air chamber is communicated with the cylinder in conjunction with a movement of the piston. The third air chamber accumulates or discharges the compressed air in the first air chamber in conjunction with the operation of the trigger. The cylinder is movable between a first position where the cylinder upper chamber being in communication with the first air chamber, and a second position where the cylinder upper chamber being blocked from the first air chamber based on a differential pressure between the second air chamber and the third air chamber.

### TECHNICAL FIELD

The invention relates to a fastening tool.

### BACKGROUND ART

As shown in FIG. 12, a conventional nail gun 101 includes a housing 102, a cylinder 103, a piston 104, a driver blade 141, a head valve 105, and a trigger 112. An accumulator chamber 102a for accumulating compressed air is formed in the housing 102. The piston 104 is accommodated in the cylinder 103 and divides the cylinder 103 into a cylinder upper chamber and a cylinder lower chamber. The driver blade 141 is fixed to the piston 104 and is configured to strike a nail (not shown). The head valve 105 is disposed above the cylinder 103. A return air chamber 134 is formed in the housing 102. The piston 104 returns to a top dead center by compressed air accumulated in the return air chamber 134. The cylinder 103 has a check valve 103A and formed with an air passage 103a in communication with the return air chamber 134. The housing 102A has an upper part formed with a head valve chamber 151 for accommodating the head valve 105. The head valve 105 allows or blocks communication between the accumulator chamber 102a and the cylinder 103 based on pressure in the head valve chamber 151.

Upon pulling the trigger 112 of the nail gun 101 by an operator, the head valve 105 moves to allow communication between the accumulator chamber 102a and the cylinder 103, so that compressed air in the accumulator chamber 102a flows into the cylinder upper chamber. This causes the piston 104 to be pushed down, and then the driver blade 141 strikes the nail (not shown) into a workpiece. With downward movement of the piston 104, air in the cylinder lower chamber and compressed air in the cylinder upper chamber flow into the return air chamber 134 via the check valve 103A and the air passage 103a.

Upon releasing the trigger 112, the head valve 105 blocks communication between the accumulator chamber 102a and the cylinder 103, and compressed air in the cylinder upper chamber is discharged to the outside through an air passage (not shown).

Japanese Patent Application Publication No. 2010-64225 discloses a method of reducing the amount of air consumption of such a nail gun. In the nail gun disclosed in Japanese Patent Application Publication No. 2010-64225, a spring for urging a cylinder downward is provided in a housing. When a trigger is operated, compressed air in a head valve chamber is discharged, a head valve moves up, compressed air flows into the cylinder, and then a piston moves downward. When pressure in a return air chamber increases with this operation, pressure in the return air chamber becomes larger than the urging force of the spring, and the cylinder moves upward and contacts the head valve. When the trigger is released, compressed air is supplied to the head valve chamber, and both of the pressure in the head valve chamber and the urging force of the spring push the cylinder downward to its initial position.

Another conventional nail gun 401 is shown in FIG. 13. To each element of the nail gun 401 in the FIG. 13, the same reference number has been applied as the like element in the nail gun 101 in FIG. 12, augmented by 300.

### DISCLOSURE OF INVENTION

### Solution to Problem

In the nail gun disclosed in JP-A-2010-64225, in order to reduce the amount of air consumption, it is effective to, by setting the urging force of the spring for urging the cylinder to a small value (i.e., weak force), shorten a time period after the head valve moves upward and before communication between the cylinder and the accumulator chamber is blocked, so as to suppress inflow of compressed air into the cylinder. On the other hand, in order to return the cylinder to the initial position reliably, it is effective to increase the urging force of the spring. Accordingly, in the nail gun disclosed in JP-A-2010-64225, it is necessary to satisfy conflicting technical problems of a prompt upper movement of the cylinder and of a reliable return to the initial position, and there is still a room for improvement on this point.

When a fastener is driven with the fastening tool disclosed in JP-A-2003-236768, a head valve moves up, and then communication between an accumulator chamber and a cylinder is allowed. Then, compressed air in the accumulator chamber flows into the cylinder so that a piston moves down abruptly to drive the fastener. Because the piston moves downward abruptly immediately after driving the fastener, pressure at the upper side of the piston is smaller than pressure in the accumulator chamber. Accordingly, compressed air in the accumulator chamber flows into the cylinder until pressure in the accumulator chamber becomes the same as pressure in the cylinder at the upper side of the piston. Compressed air that flows into the cylinder after the fastener is driven, that is, after the piston reaches the bottom dead center is discharged without doing work. In addition, because a return air chamber is brought into communication with the accumulator chamber in the middle of downward movement of the piston, useless compressed air flows into the return air chamber. Further, an increase in pressure in the return air chamber hinders downward movement of the piston, and becomes a factor for a drop in the driving force (striking force).

In view of the foregoing, it is an object of the invention to provide a fastening tool that can obtain effects of reducing the amount of air consumption stably and sufficiently. Another object of the invention is to provide a fastening tool that can reduce the amount of air consumption and increase the driving force (striking force) of the piston.

In order to attain above and other objects, the present invention provides a fastening tool. The fastening tool includes a housing, a trigger, a cylinder, a piston, and a main valve. The housing defines a first air chamber for accumulating compressed air. The trigger is provided at the housing. The cylinder is accommodated in the housing. The piston is accommodated in the cylinder and divides the cylinder into a cylinder upper chamber and a cylinder lower chamber. The main valve is configured to allow a communication between the cylinder and the first air chamber in conjunction with an operation of the trigger. The housing is formed with a second air chamber and a third air chamber. The second air chamber is communicated with the cylinder upper chamber in conjunction with a movement of the piston, and the third air chamber accumulates or discharges the compressed air in the first air chamber in conjunction with the operation of the trigger. The cylinder is movable between a first position where the cylinder upper chamber being in communication with the first air chamber, and a second position where the cylinder upper chamber being blocked from the first air chamber based on a differential pressure between the second air chamber and the third air chamber.

Preferably, the trigger comprises a trigger valve section for allowing and blocking a communication between the first air chamber and the third air chamber in conjunction with the operation of the trigger. The housing is formed with an air passage having one end opening connected to the third air chamber and another end opening connected to the trigger valve section. The cylinder is configured to block at least part of the one end opening.

Preferably, the trigger comprises a trigger valve section for allowing and blocking a communication between the first air chamber and the third air chamber in conjunction with the operation of the trigger. The housing is formed with an air passage having one end opening connected to the third air chamber and another end opening connected to the trigger valve section, the cylinder being configured to block at least part of the one end opening.

Preferably, the housing defines a fourth air chamber in communication with the third air chamber, the trigger valve section allowing and blocking a communication between the fourth air chamber and the first air chamber, the main valve allowing the communication between the cylinder and the first air chamber based on a pressure of the fourth air chamber.

According to another aspect of the invention, the present invention provide a fastening tool. The fastening tool includes a housing, a trigger, a cylinder, a piston, a bumper, a main valve, and a cylinder driving mechanism. The housing defines an accumulator chamber for accumulating compressed air. The trigger is provided at the housing. The cylinder is accommodated in the housing and movable between a first position and a second position. The piston is slidably accommodated in the cylinder in a sliding direction between a top dead center and a bottom dead center. The piston divides the cylinder into a cylinder upper chamber and a cylinder lower chamber. The bumper is accommodated in the housing. The piston is configured to contact the bumper. The main valve is configured to allow a communication between the cylinder and the accumulator chamber in conjunction with an operation of the trigger. The cylinder upper chamber is defined by the main valve, the piston, and the cylinder. The cylinder driving mechanism is configured to move the cylinder in the sliding direction. The housing is formed with a return air chamber communicated with the cylinder upper chamber in conjunction with a movement of the piston. The cylinder driving mechanism comprises a cylinder drive chamber formed at the housing and communicated with the cylinder lower chamber when the piston is positioned at the top dead center. When the piston moves in the sliding direction so that a communication between the cylinder upper chamber and the cylinder drive chamber is provided, the cylinder moves from the first position to the second position. The first position is a position where a communication between the cylinder upper chamber and the return air chamber is blocked, and the second position is a position where the communication between the cylinder upper chamber and the return air chamber is allowable and a communication between the cylinder upper chamber and the accumulator chamber is blocked.

Preferably, the return air chamber is constantly communicated with the cylinder lower chamber.

Preferably, the cylinder driving mechanism comprises a cylinder urging chamber formed in the housing and configured to be communicated with the accumulator chamber in conjunction with the operation of the trigger. The cylinder moves from the second position to the first position when the cylinder urging chamber is communicated with the accumulator chamber.

Preferably, the cylinder urging chamber is provided with an urging member for urging the cylinder from the second position to the first position

Preferably, the housing defines a head valve chamber configured to communicate with the accumulator chamber in conjunction with the operation of the trigger. The main valve blocks the communication between the cylinder and the accumulator chamber when the head valve chamber is communicated with the accumulator chamber. The head valve chamber is constantly communicated with the cylinder urging chamber.

According to still another aspect of the invention, the present invention provide a fastening tool. The fastening tool includes a housing, a trigger, a cylinder, a piston, a bumper, a main valve, and a cylinder driving mechanism. The housing defines an accumulator chamber for accumulating compressed air. The trigger is provided at the housing. The cylinder is accommodated in the housing and is movable between a first position and a second position. The piston is slidably movably accommodated in the cylinder in a sliding direction. The piston divides the cylinder into a cylinder upper chamber and a cylinder lower chamber. The bumper is accommodated in the housing. The piston is configured to contact the bumper. The cylinder lower chamber is defined by the bumper, the cylinder, and the piston. The main valve is configured to allow a communication between the cylinder and the accumulator chamber in conjunction with an operation of the trigger. The cylinder upper chamber is defined by the main valve, the piston, and the cylinder. The cylinder driving mechanism is configured to move the cylinder in the sliding direction. The housing is formed with a return air chamber communicated with the cylinder in conjunction with a movement of the piston and accumulating the compressed air which has flowed into the cylinder. The cylinder driving mechanism move the cylinder from the first position to the second position after the main valve allow the communication between the cylinder and the accumulator chamber. The first position is a position where a communication between the cylinder upper chamber and the return air chamber is blocked, and the second position is a position where the communication between the cylinder upper chamber and the return air chamber is allowable and a communication between the cylinder upper chamber and the accumulator chamber is blocked.

Preferably, the return air chamber is constantly communicated with the cylinder lower chamber.

Preferably, the piston is movable between a top dead center and a bottom dead center. The cylinder driving mechanism comprises a cylinder drive chamber formed at the housing and communicated with the cylinder lower chamber when the piston is positioned at the top dead center. The cylinder moves from the first position to the second position when the cylinder upper chamber is communicated with the cylinder drive chamber.

Preferably, the housing defines a head valve chamber configured to communicate with the accumulator chamber in conjunction with the operation of the trigger. The cylinder driving mechanism comprises a cylinder urging chamber formed in the housing and configured to be communicated with the accumulator chamber in conjunction with the operation of the trigger. The cylinder moves from the second position to the first position when the cylinder urging chamber is communicated with the accumulator chamber.

Preferably, the cylinder urging chamber is provided with an urging member for urging the cylinder from the second position to the first position.

Preferably, the main valve blocks the communication between the cylinder and the accumulator chamber when the head valve chamber is communicated with the accumulator chamber. The head valve chamber is constantly communicated with the cylinder urging chamber.

### Advantageous Effects of Invention

According to the fastening tool, effects of reducing the amount of air consumption can be obtained stably and sufficiently. Further, according to the fastening tool, the amount of air consumption can reduce and the driving force (striking force) of the piston can increase.

### BRIEF DESCRIPTION OF DRAWINGS

FIG. 1 is a partial cross-sectional view showing a fastening tool in an initial state according to a first embodiment of the present invention.

FIG. 2 is a partial cross-sectional view showing the fastening tool in a state where a piston is moving downward according to the first embodiment of the present invention.

FIG. 3 is a partial cross-sectional view showing the fastening tool in a state where the piston is in contact with a bumper according to the first embodiment of the present invention.

FIG. 4 is a partial cross-sectional view showing a fastening tool in an initial state according to a second embodiment of the present invention.

FIG. 5 is a partial cross-sectional view showing the fastening tool in a state where a cylinder is in pneumatic communication with an accumulator chamber according to the second embodiment of the present invention.

FIG. 6 is a partial cross-sectional view showing the fastening tool in a state where a piston is in contact with a bumper according to the second embodiment of the present invention.

FIG. 7 is a partial cross-sectional view showing a fastening tool in an initial state according to a third embodiment of the present invention.

FIG. 8 is a partial enlarged cross-sectional view showing the fastening tool in an initial state according to the third embodiment of the present invention.

FIG. 9 is a partial enlarged cross-sectional view showing the fastening tool in a state where a head valve is moving upward according to the third embodiment of the present invention.

FIG. 10 is a partial enlarged cross-sectional view showing the fastening tool in a state where a piston is in contact with a dumper and a cylinder is moving upward according to the third embodiment of the present invention.

FIG. 11 is a partial enlarged cross-sectional view showing the fastening tool in a state where the head valve moves the cylinder downward according to the third embodiment of the present invention.

FIG. 12 is a partial cross-sectional view showing a conventional fastening tool.

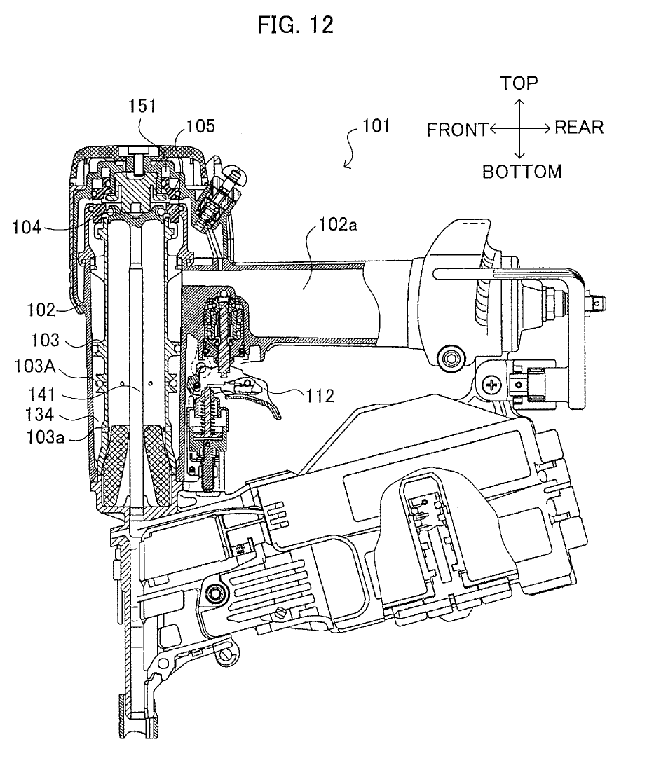

FIG. 13 is a partial cross-sectional view showing a conventional fastening tool.

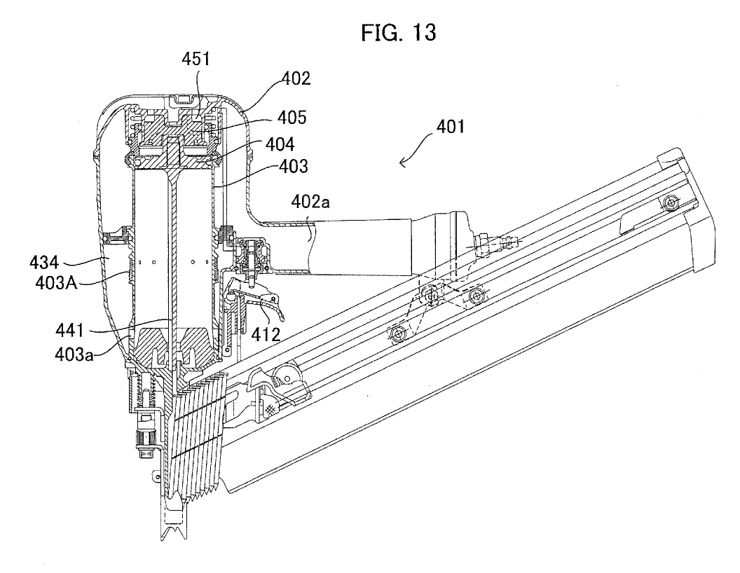

### REFERENCE SIGNS LIST

1 nail gun
2 housing
3 cylinder
4 piston
5 head valve
6 nose section
11 nail
12 trigger
14 trigger valve section
14a control passage
31 flange section
32 partition wall
33 cylinder control chamber
34 return air chamber
35 cylinder upper chamber
36 cylinder lower chamber
41 driver blade
43 bumper
51 head valve chamber

### BEST MODE FOR CARRYING OUT THE INVENTION

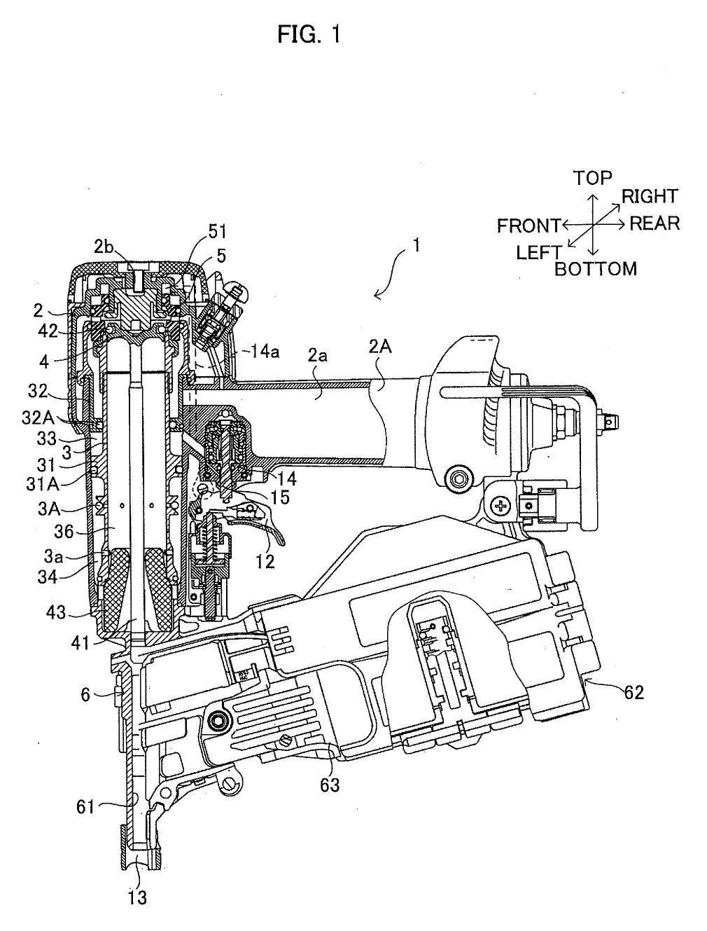

A first embodiment of the invention will be described while referring to FIGS. 1 through 3. A nail gun 1 embodying a fastening tool of the invention is a tool for driving a nail (not shown) as a fastener, and use compressed air as its power.

The nail gun 1 includes a housing 2, a cylinder 3 accommodated in the housing 2, a piston 4 accommodated in the cylinder 3, a head valve 5 accommodated in the housing 2, and a nose section 6 extending from the housing 2. The housing 2 includes a handle 2A located at one side of the housing 2. In FIG. 1, a direction in which the handle 2A extends from the housing 2 is defined as the rear, and the opposite direction is defined as the front. A direction in which the nose section 6 extends from the housing 2 is defined as the bottom, and the opposite direction is defined as the top. Further, a direction perpendicular to both the front-rear direction and the upper-lower direction is defined as the left-right direction (the near side of the drawing sheet of FIG. 1 is the left direction, and the far side of the drawing sheet is the right direction).

An accumulator chamber 2a is formed in the handle 2A and the housing 2 for accumulating compressed air from a compressor (not shown). The accumulator chamber 2a is connected with the compressor through an air hose (not shown). An air outlet 2b in communication with the outside is formed at an upper part of the housing 2. The accumulator chamber 2a serves as a first air chamber of the invention.

A trigger 12, a push lever 13, a trigger valve section 14, and a plunger 15 are provided at a base part of the handle 2A. The trigger 12 is operated by an operator. The push lever 13 protrudes from the lower end of the nose section 6 and extends to a neighborhood of the trigger 12. The trigger valve section 14 is in communication with a head valve chamber 51 described later and serves as a switching valve for sending and discharging compressed air. The plunger 15 transmits motion of the trigger 12 to the trigger valve section 14. The push lever 13 is urged in a direction from the housing 2 toward the nose section 6, and is movable in the upper-lower direction along the nose section 6. The housing 2A is formed with a control passage 14a. The trigger valve section 14 is in communication with a cylinder control chamber 33 and the head valve chamber 51, both to be described later, through the control passage 14a.

The plunger 15 of the trigger valve section 14 can be pushed upward when both of a pulling operation of the trigger 12 and a pressing operation of the push lever 13 against a workpiece are performed.

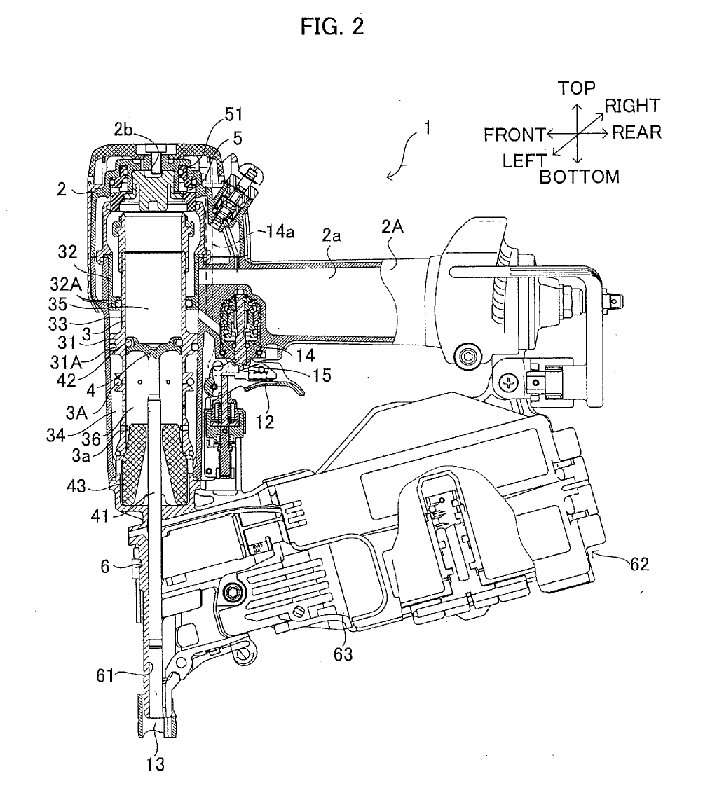

The cylinder 3 has substantially a cylindrical shape. The inside of the cylinder 3 is separated by the piston 4 into a cylinder upper chamber 35 (FIG. 2) and a cylinder lower chamber 36. A flange section 31 is provided at substantially a center part of the cylinder 3 in the upper-lower direction. The flange section 31 protrudes outward in a radial direction of the cylinder 3 from an outer circumferential surface thereof. A partition wall 32 is provided above the flange section 31. The partition wall 32 is in sliding contact with the outer circumference of the cylinder 3 and is fixed to the housing 2.

The housing 2 is formed with the cylinder control chamber 33 above the flange section 31 and defined by the outer circumferential surface of the cylinder 3, the flange section 31, the housing 2, and the partition wall 32. The partition wall 32 is provided with two O-rings 32A blocking pneumatic communication between the accumulator chamber 2a and the cylinder control chamber 33. The flange section 31 is provided with an O-ring 31A blocking pneumatic communication between the cylinder control chamber 33 and a return air chamber 34 described later. The cylinder control chamber 33 is in communication with the trigger valve section 14 through the control passage 14a. The cylinder control chamber 33 serves as a third air chamber of the invention.

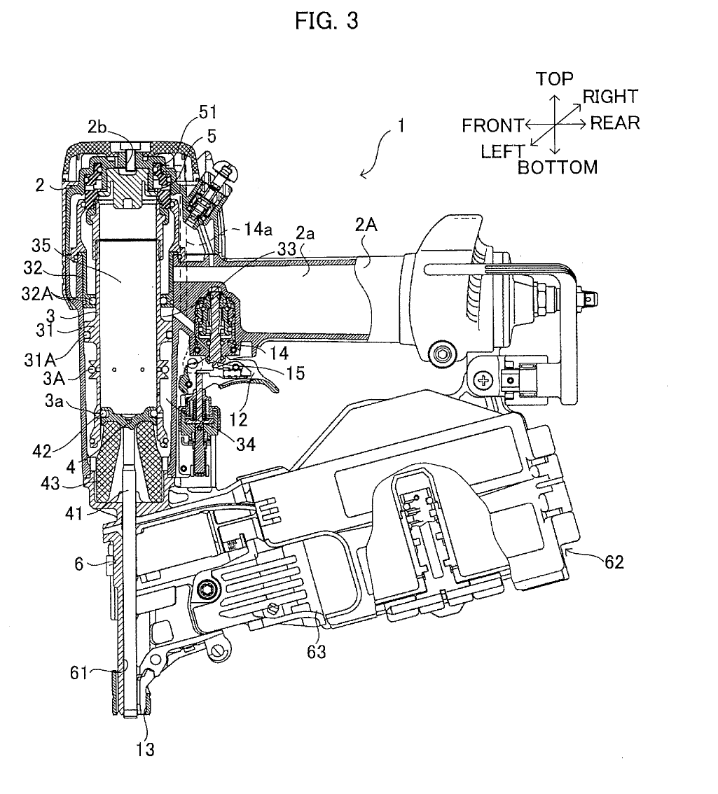

The cylinder 3 is movable in the upper-lower direction between: a top dead center at which the upper end of the cylinder 3 is in contact with the head valve 5 and at which the lower end of the cylinder 3 is spaced away from a bumper 43 described later (FIG. 3); and a bottom dead center at which the lower end of the cylinder 3 is in contact with the bumper 43 described later (FIG. 1). The top dead center serves as a second position of the invention, and the bottom dead center serves as a first position of the invention.

The return air chamber 34 is formed at a lower outer circumference of the cylinder 3 for storing compressed air for returning the piston 4 to an initial state (FIG. 1). The cylinder 3 has a lower part provided with a check valve 3A allowing only inflow from the cylinder 3 to the return air chamber 34. An air passage 3a is formed directly below the check valve 3A. The volume of the return air chamber 34 is larger than that of the cylinder control chamber 33. The return air chamber 34 serves as a second air chamber of the invention.

The piston 4 is slidingly movable within the cylinder 3 in the upper-lower direction. The piston 4 is fixed with a driver blade 41 extending downward. A piston ring 42 is fitted over the outer circumference of the piston 4 for blocking pneumatic communication between the cylinder upper chamber 35 and the cylinder lower chamber 36. The bumper 43 is provided below the cylinder 3 for absorbing excess energy of the piston 4 after driving a nail (not shown). The bumper 43 is made of elastic material such as urethane or nitrile butadiene rubber (NBR).

The head valve 5 is disposed above the cylinder 3. An air passage (not shown) allowing communication with the air outlet 2b is formed in the head valve 5. The head valve chamber 51 for accommodating the head valve 5 is formed in the housing 2. The head valve chamber 51 is in communication with the trigger valve section 14 and the cylinder control chamber 33 via the control passage 14a. In the initial state shown in FIG. 1, the head valve chamber 51 is filled with compressed air, and the head valve 5 is urged downward by compressed air in the head valve chamber 51. The head valve chamber 51 serves as a fourth air chamber of the invention.

The nose section 6 is located at a lower end of the housing 2. The nose section 6 is formed with a guiding passage 61 for guiding the driver blade 41 and a nail (not shown). An injection hole through which a nail (not shown) is injected is defined at the lowest position of the guiding passage 61. A magazine device 62 is provided at the rear side of the nose section 6 for accommodating a bundle of nails made by binding a plurality of nails (not shown). The magazine device 62 is provided with a nail feeder for sequentially feeding nails (not shown) loaded at a magazine 63 into the guiding passage 61.

Next, the operation of the nail gun 1 will be described.

When the air hose (not shown) is connected to the nail gun 1, a portion of compressed air accumulated in the accumulator chamber 2a flows into the head valve chamber 51 and the cylinder control chamber 33 via the trigger valve section 14 and the control passage 14a. Compressed air sent to the head valve chamber 51 pushes the head valve 5 downward, thereby getting the head valve 5 and the cylinder 3 into a closer contact with each other, so as to prevent compressed air from flowing into the cylinder 3. The cylinder 3 is urged downward by the head valve 5 and compressed air in the cylinder control chamber 33, and is located at the bottom dead center.

When the operator pulls the trigger 12 while pressing the push lever 13 against the workpiece, the plunger 15 is pushed up and the trigger valve section 14 allows the control passage 14a in communication with ambient air so that pressure in the head valve chamber 51 and in the cylinder control chamber 33 becomes atmospheric pressure. The head valve 5 moves upward due to differential pressure between compressed air accumulated in the accumulator chamber 2a and the head valve chamber 51. Hence, compressed air accumulated in the accumulator chamber 2a flows into the cylinder upper chamber 35 to promptly push the piston 4 downward. Here, the nail gun 1 changes from the state shown in FIG. 1 to the state shown in FIG. 2. At this time, the cylinder control chamber 33 becomes atmospheric pressure, and the return air chamber 34 is also atmospheric pressure. Hence, the cylinder 3 remains located at the bottom dead center.

As the piston 4 moves downward, air in the cylinder lower chamber 36 flows into the return air chamber 34 via the check valve 3A and the air passage 3a. When the piston 4 passes the check valve 3A, compressed air in the cylinder upper chamber 35 also flows into the return air chamber 34 to push the flange section 31 upward. Then, as shown in FIG. 3, when the piston 4 contacts the bumper 43, the cylinder 3 moves to the top dead center. Due to this downward movement of the piston 4, the nail (not shown) is driven into the workpiece. When the cylinder 3 moves to the top dead center, the upper end of the cylinder 3 is in contact with the head valve 5 to block communication between the accumulator chamber 2a and the cylinder upper chamber 35. This prevents compressed air from excessively flowing into the cylinder upper chamber 35.

When the operator releases the trigger 12, the plunger 15 returns, and compressed air is supplied to the cylinder control chamber 33 and to the head valve chamber 51 via the control passage 14a. This causes the head valve 5 to move downward. The cylinder 3 is pressed downward by compressed air in the head valve chamber 51 and in the cylinder control chamber 33, and the head valve 5 and the cylinder 3 move downward in an integrated manner. Thus, the cylinder 3 moves to the bottom dead center. At the same time, the cylinder upper chamber 35 is brought into communication with the air outlet 2b via the air passage (not shown), and pressure of the cylinder upper chamber 35 becomes atmospheric pressure. Then, compressed air accumulated in the return air chamber 34 flows into the cylinder lower chamber 36 via the air passage 3a. This causes the piston 4 to be pushed upward, and the nail gun 1 is in the initial state shown in FIG. 1.

With this configuration, because the cylinder 3 is moved by pressure of compressed air accumulated in the cylinder control chamber 33, the cylinder 3 can be moved stably. Further, movement of the cylinder 3 to the top dead center blocks communication between the accumulator chamber 2a and the cylinder upper chamber 35, which suppresses excessive flow of the compressed air into the cylinder upper chamber 35. Thus, the amount of air consumption can be reduced stably.

With this configuration, after the head valve 5 allows communication between the cylinder upper chamber 35 and the accumulator chamber 2a, communication between the cylinder upper chamber 35 and the accumulator chamber 2a is blocked. This prevents excess compressed air from flowing into the cylinder upper chamber 35. Thus, the amount of air consumption can be reduced stably.

With this configuration, when the piston 4 has driven a nail (not shown) (i.e., when the piston 4 makes contact with the bumper 43), the cylinder 3 moves to the top dead center to block communication between the cylinder upper chamber 35 and the accumulator chamber 2a. Hence, the piston 4 can be supplied with sufficient energy until driving of the nail (not shown) is completely finished.

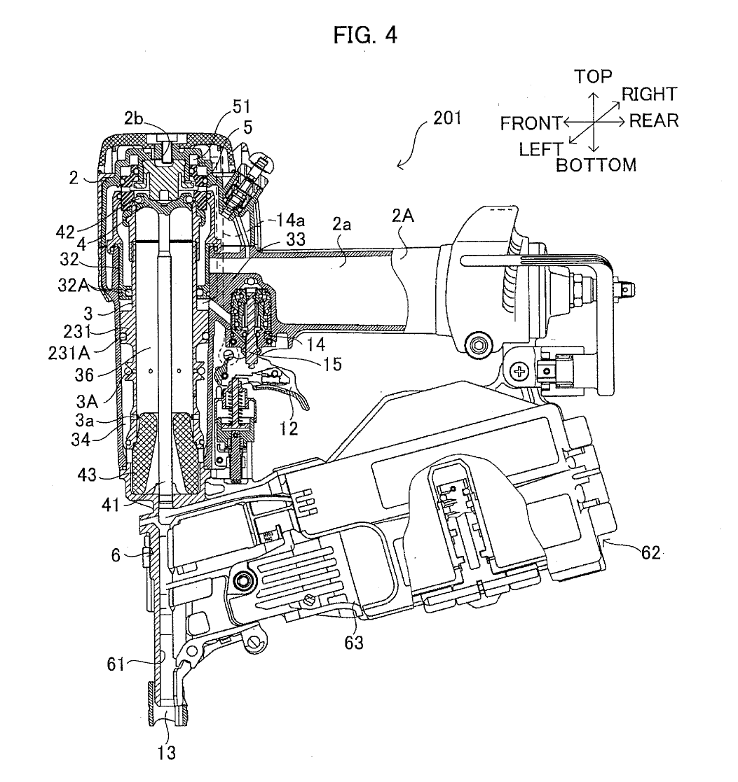

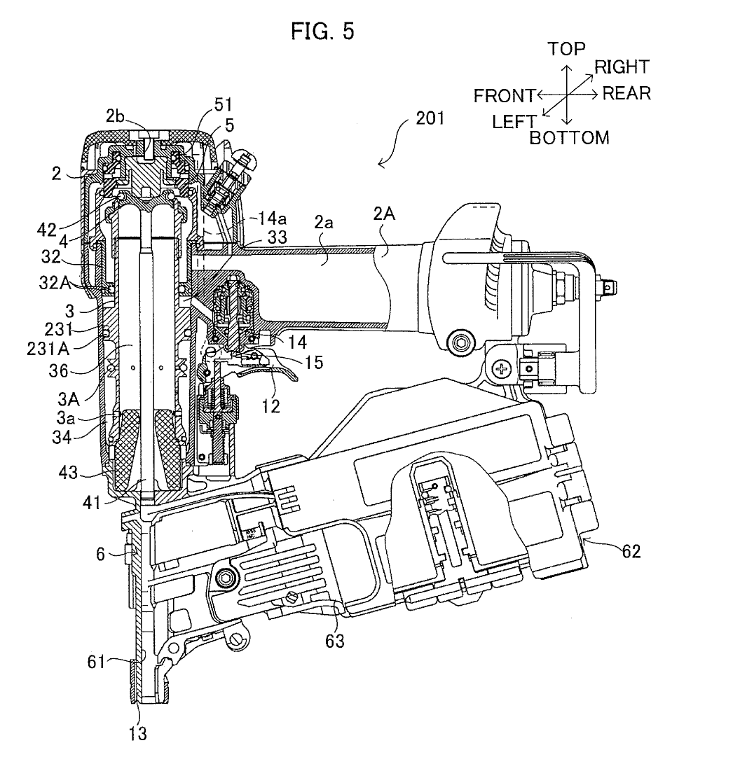

Next, a nail gun 201 according to a second embodiment of the invention will be described while referring to FIGS. 4 through 6, wherein like parts and components are designated by the same reference numerals to avoid duplicating description.

A flange section 231 is provided at substantially a center part of the cylinder 3 in the upper-lower direction. The flange section 231 protrudes outward in the radial direction from an outer circumferential surface of the cylinder 3. The length of the flange section 231 in the upper-lower direction in the second embodiment is longer than the length of the flange section 31 in the upper-lower direction in the first embodiment. The flange section 231 is provided with an O-ring 231A blocking pneumatic communication between the cylinder control chamber 33 and the return air chamber 34.

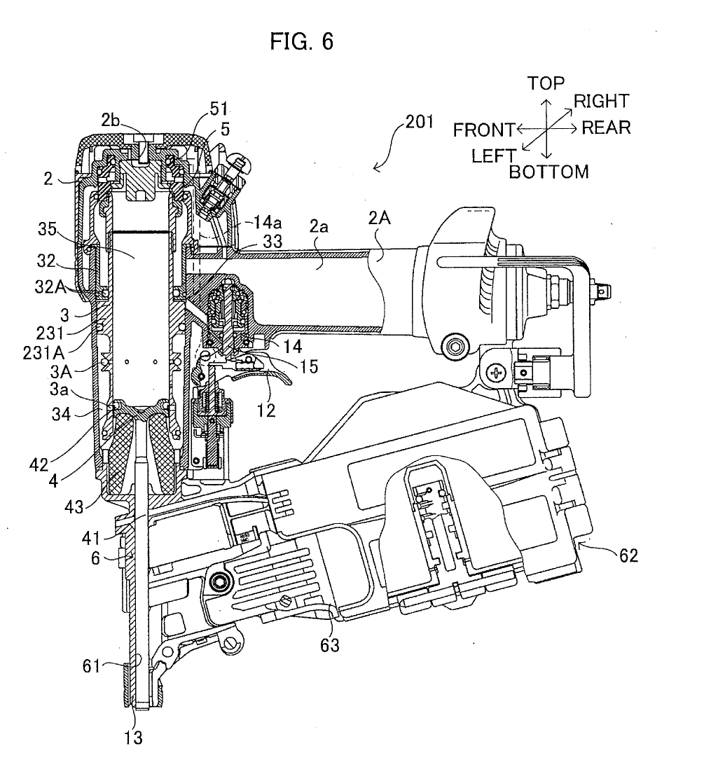

The cylinder 3 is movable in the upper-lower direction between: a top dead center at which the upper end of the cylinder 3 is in contact with the head valve 5 and at which the upper surface of the flange section 231 is adjacent to the partition wall 32 (FIG. 6); and a bottom dead center at which the lower end of the cylinder 3 is in contact with the bumper 43 and the upper surface of the flange section 231 is spaced away from the partition wall 32 (FIG. 4).

In order to obtain effects of reducing the amount of air consumption to a maximum extent in the nail gun 201, it is necessary to shorten a time period after the trigger 12 is pulled to allow communication between the cylinder upper chamber 35 and the accumulator chamber 2a and before the cylinder 3 moves to the top dead center to block communication between the cylinder upper chamber 35 and the accumulator chamber 2a, for suppressing inflow of compressed air from the accumulator chamber 2a to the cylinder upper chamber 35 to a minimum level. Thus, it is important to promptly discharge compressed air in the cylinder control chamber 33, so that compressed air in the cylinder control chamber 33 does not act as a drag when the cylinder 3 is pushed upward by pressure of the return air chamber 34. In the second embodiment, the volume of the cylinder control chamber 33 is smaller than that in the first embodiment. With this configuration, compressed air in the cylinder control chamber 33 can be discharged promptly.

Further, in case that the volume of the cylinder control chamber 33 is reduced, pressure in the cylinder control chamber 33 increases abruptly when the trigger 12 is released and compressed air flows into the cylinder control chamber 33. Hence, the cylinder 3 may move to the bottom dead center at earlier timing than timing when the head valve chamber 51 is filled with compressed air and the head valve 5 moves downward. Then, because the cylinder 3 is spaced away from the head valve 5 and the cylinder upper chamber 35 becomes communicated with the accumulator chamber 2a, compressed air flows into the cylinder upper chamber 35 and the amount of air consumption increases. In the second embodiment, however, as shown in FIG. 6, when the cylinder 3 is located at the top dead center, a side surface of the flange section 231 blocks a large part of the opening of the control passage 14a. Thus, even if compressed air flows into the cylinder control chamber 33 in this state, a rapid pressure increase in the cylinder control chamber 33 can be suppressed.

With this configuration, because at least part of the opening of the control passage 14a is blocked by the cylinder 3, a rapid pressure increase in the cylinder control chamber 33 can be prevented. This prevents a situation in which pressure in the cylinder control chamber 33 increases abruptly, and the cylinder 3 moves to the bottom dead center, and compressed air in the accumulator chamber 2a flows into the cylinder upper chamber 35. Thus, an increase in the amount of air consumption can be prevented.

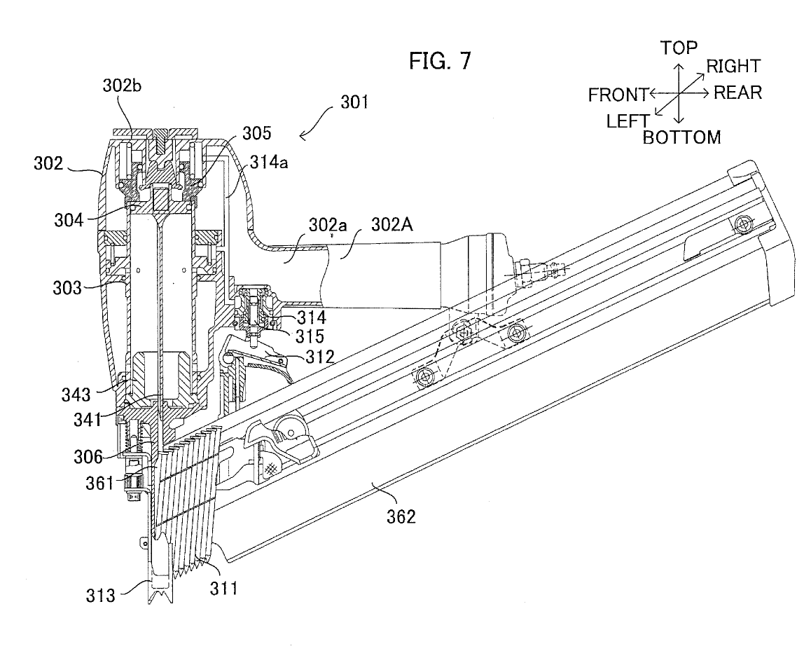

Next, a nail gun 301 according to a third embodiment of the invention will be described while referring to FIGS. 7 through 11. The nail gun 301 embodying a fastening tool of the invention is a tool for driving a nail 311 as a fastener, and use compressed air as its power.

As shown in FIG. 7, the nail gun 301 includes a housing 302, a cylinder 303 accommodated in the housing 302, a piston 304 accommodated in the cylinder 303, a head valve 305 accommodated in the housing 302, and a nose section 306 extending from the housing 302. The housing 302 includes a handle 302A located at one side of the housing 302. The head valve 305 is movable between a contact position where the head valve 305 is in contact with the cylinder 303 and a spaced position where the head valve 305 is spaced away from the cylinder 303. The front, rear, upper, lower, left, and right directions are defined in the same way as the previous embodiments. The head valve 305 serves as a main valve of the invention.

An accumulator chamber 302a is formed in the handle 302A and the housing 302 for accumulating compressed air from a compressor (not shown). The accumulator chamber 302a is connected with the compressor through an air hose (not shown). The housing 302 has an upper part formed with an air outlet 302b in communication with the outside. The accumulator chamber 302a serves as a first air chamber of the invention.

A trigger 312, a push lever 313, a trigger valve section 314, and a plunger 315 are provided at a base part of the handle 302A. The trigger 312 is operated by an operator. The push lever 313 protrudes from the lower end of the nose section 306 and extends to a neighborhood of the trigger 312. The trigger valve section 314 is in communication with a head valve chamber 351 described later and serves as a switching valve for sending and discharging compressed air. The plunger 315 transmits motion of the trigger 312 to the trigger valve section 314. The push lever 313 is urged in a direction from the housing 302 toward the nose section 306, and is movable in the upper-lower direction along the nose section 306. A control passage 314a is formed in the housing 302. The trigger valve section 314 is in communication with a cylinder urging chamber 333 and the head valve chamber 351, both to be described later, through the control passage 314a. The plunger 315 of the trigger valve section 314 is configured to be pushed upward when both of a pulling operation of the trigger 312 and a pressing operation of the push lever 313 against a workpiece are performed.

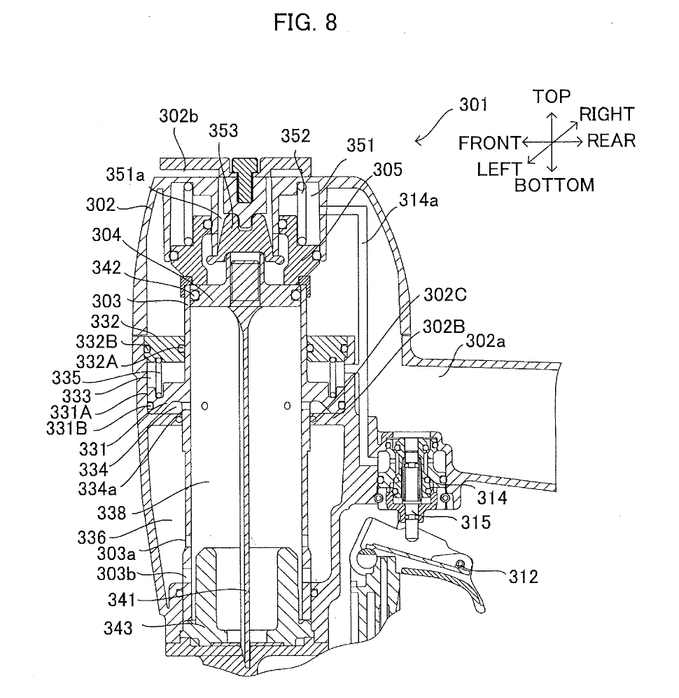

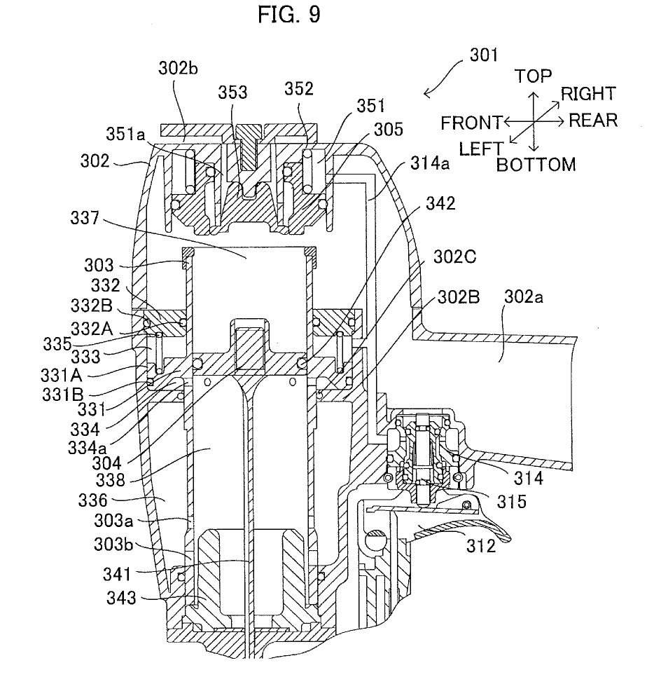

The cylinder 303 has substantially a cylindrical shape. The inside of the cylinder 303 is separated by the piston 304 into a cylinder upper chamber 337 (FIG. 9) and a cylinder lower chamber 338. As shown in FIG. 8, a flange section 331 is provided at substantially a center part of the cylinder 303 in the upper-lower direction. The flange section 331 protrudes outward in the radial direction from an outer circumferential surface of the cylinder 303. The flange section 331 has an outer circumferential surface 331A in sliding contact with the housing 302. A cylinder plate 332 having an annular shape and fixed to the housing 302 is provided above the flange section 331. An inner circumferential surface of the cylinder plate 332 is in sliding contact with the outer circumference of the cylinder 303. A wall section 302B is provided directly below the flange section 331. The wall section 302B protrudes from the housing 302 inward in the radial direction of the cylinder 303, and is in contact with the outer circumferential surface of the cylinder 303. The cylinder 303 is slidable relative to the wall section 302B.

The cylinder urging chamber 333 is formed above the flange section 331 by the outer circumferential surface of the cylinder 303, the flange section 331, the housing 302, and the cylinder plate 332. A cylinder drive chamber 334 is formed below the flange section 331 by the outer circumferential surface of the cylinder 303, the flange section 331, and the wall section 302B. The cylinder plate 332 is provided with two O-rings 332A and 332B blocking pneumatic communication between the accumulator chamber 302a and the cylinder urging chamber 333. An O-ring 331B is provided at the outer circumferential surface 331A of the flange section 331 for blocking pneumatic communication between the cylinder urging chamber 333 and the cylinder drive chamber 334.

The wall section 302B is provided with an O-ring 302C blocking pneumatic communication between the cylinder drive chamber 334 and a return air chamber 336 described later. The cylinder urging chamber 333 is in communication with the trigger valve section 314 through the control passage 314a. The cylinder urging chamber 333 is provided with a spring 335 having one end in contact with the cylinder plate 332 and another end in contact with the flange section 331 for urging the flange section 331 downward. The cylinder 3 is formed with an air passage 334a allowing communication between the cylinder drive chamber 334 and the inside of the cylinder 303. The flange section 331, the cylinder urging chamber 333, the cylinder drive chamber 334, and the spring 335 serve as a cylinder driving mechanism of the invention. The cylinder urging chamber 333 serves as a third air chamber of the invention, and the cylinder drive chamber 334 serves as a second air chamber of the invention.

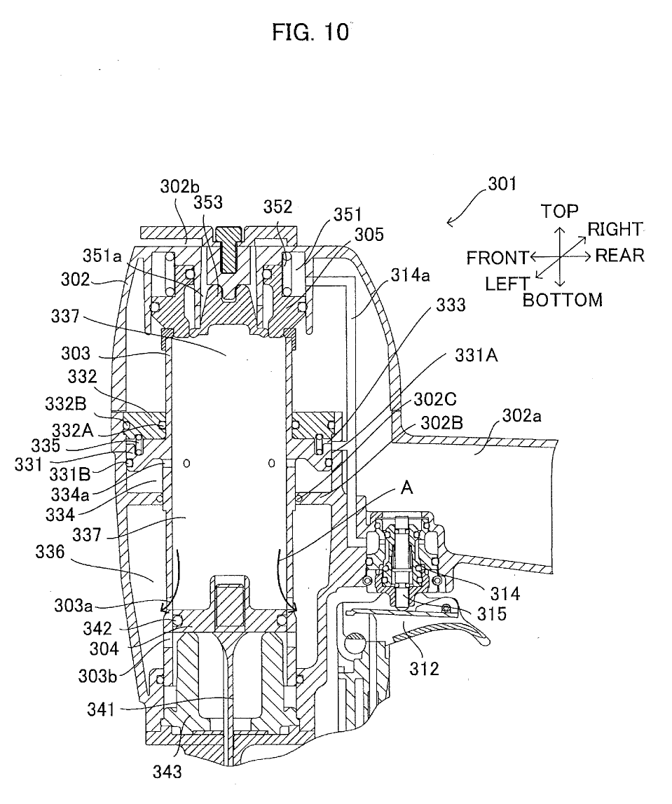

The cylinder 303 is movable in the upper-lower direction between: a top dead center at which the upper surface of the flange section 331 is in contact with the cylinder plate 332 and the upper end of the cylinder 3 is in contact with the head valve 305 in a state where the head valve 305 is located at the spaced position (FIG. 10); and a bottom dead center at which the lower end of the flange section 331 is in contact with the wall section 302B of the housing 302 and the lower end of the cylinder 303 is in contact with a bumper 343 described later (FIG. 9). The top dead center serves as a second position of the invention, and the bottom dead center serves as a first position of the invention.

The return air chamber 336 is formed at a lower outer circumference of the cylinder 303 for storing compressed air for returning the piston 304 to an initial state (FIG. 7). The cylinder 303 has a lower part formed with a first air passage 303a in communication with the return air chamber 336 and a second air passage 303b directly below the first air passage 303a. Specifically, as shown in FIG. 10, the first air passage 303a is formed at such a position that the cylinder upper chamber 337 is in communication with the return air chamber 336 when the piston 304 is in contact with the bumper 343 described later and the cylinder 303 has moved to the top dead center. Similarly, the second air passage 303b is formed at such a position that the cylinder lower chamber 338 is in communication with the return air chamber 336 when the piston 304 is in contact with the bumper 343 described later and the cylinder 303 has moved to the top dead center. That is, the cylinder lower chamber 338 is constantly in communication with the return air chamber 336 regardless of the position the piston 304 and the cylinder 303. The volume of the return air chamber 336 is larger than that of the cylinder urging chamber 333.

The piston 304 can slide within the cylinder 303 in the upper-lower direction. The piston 304 is fixed to a driver blade 341 extending downward. A piston ring 342 is fitted over the outer circumference of the piston 304 for blocking pneumatic communication between the cylinder upper chamber 337 and the cylinder lower chamber 338. The bumper 343 is provided at the lower part of the cylinder 303 for absorbing excess energy of the piston 304 after driving the nail 311. The bumper 343 is made of elastic material such as urethane or nitrile butadiene rubber (NBR).

The head valve 305 is disposed above the cylinder 303. The head valve chamber 351 for accommodating the head valve 305 is formed in the housing 302. The head valve chamber 351 is provided with a head valve spring 352 for urging the head valve 305 downward. A head bumper 353 is provided inside the head valve 305. The head valve 305 is formed with an air passage 351a communicated with the air outlet 302b. When the head valve 305 is located at the spaced position (FIG. 9), the head bumper 353 blocks communication between the accumulator chamber 302a (the cylinder upper chamber 337) and the air outlet 302b. The head valve chamber 351 is in communication with the trigger valve section 314 and the cylinder urging chamber 333 via the control passage 314a.

In the initial state shown in FIG. 7, the head valve chamber 351 is filled with compressed air, and the head valve 305 is urged downward by compressed air in the head valve chamber 351 and by the head valve spring 352. The force of the head valve spring 352 for urging the head valve 305 downward is smaller than the force of compressed air in the accumulator chamber 302a for pushing the head valve 305 upward. Accordingly, when compressed air in the head valve chamber 351 is discharged and pressure in the head valve chamber 351 becomes atmospheric pressure, the head valve 305 moves upward against the urging force of the head valve spring 352. The head valve chamber 351 serves as a fourth air chamber of the invention.

As shown in FIG. 7, the nose section 306 is located at a lower end of the housing 302. A guiding passage 361 for guiding the driver blade 341 and the nail 311 is formed in the nose section 306. An injection hole through which the nail 311 is injected is defined at the lowest position of the guiding passage 361. A magazine device 362 is provided at the rear side of for accommodating a bundle of nails that is made by binding a plurality of the nails 311. The magazine device 362 is provided with a nail feeder for sequentially feeding the nails 311 loaded at a magazine 363 into the guiding passage 361.

Next, the operation of the nail gun 301 will be described.

When the air hose (not shown) is connected to the nail gun 301, compressed air is accumulated in the accumulator chamber 302a, and a portion of the compressed air flows into the head valve chamber 351 and the cylinder urging chamber 333 via the trigger valve section 314 and the control passage 314a. Compressed air sent to the head valve chamber 351 pushes the head valve 305 downward, thereby getting the head valve 305 and the cylinder 303 into a closer contact with each other, so as to prevent compressed air from flowing into the cylinder 303. The cylinder 303 is urged downward by the head valve 305, the spring 335, and compressed air in the cylinder urging chamber 333, and thus is located at the bottom dead center.

When the operator pulls the trigger 312 while pressing the push lever 313 against the workpiece, the plunger 315 is moved upward and the trigger valve section 314 allows communication between the control passage 314a and ambient air so that pressure in the head valve chamber 351 and in the cylinder urging chamber 333 becomes atmospheric pressure. The head valve 305 moves upward due to differential pressure between compressed air accumulated in the accumulator chamber 302a and the head valve chamber 351. Hence, compressed air accumulated in the accumulator chamber 302a flows into the cylinder upper chamber 337 to push the piston 304 downward. Here, the nail gun 301 changes from the state shown in FIG. 8 to the state shown in FIG. 9. At this time, the cylinder 303 is located at the bottom dead center due to the urging force of the spring 335.

When the piston 304 passes the air passage 334a, compressed air in the cylinder upper chamber 337 flows into the cylinder drive chamber 334 and urges the flange section 331 upward. As the piston 304 moves downward, air in the cylinder lower chamber 338 is flowed into the return air chamber 336 via the first and second air passages 303a, 303b. When the piston 304 moves further downward and contacts the bumper 343, the first air passage 303a is blocked by the side surface of the piston 304. Compressed air in the cylinder drive chamber 334 causes the cylinder 303 to move to the top dead center against the urging force of the spring 335.

As shown in FIG. 10, when the cylinder 3 is located at the top dead center, communication between the cylinder upper chamber 337 and the accumulator chamber 302a is blocked, and communication between the cylinder upper chamber 337 and the return air chamber 336 is allowed via the first air passage 303a. As indicated by arrows A, compressed air in the cylinder upper chamber 337 flows into the return air chamber 336. At this time, the outer circumferential surface 331A blocks a portion of the opening of the control passage 314a of the cylinder urging chamber 333. With this movement of the piston 304, the nail 311 is driven into the workpiece. In the present embodiment, when the piston 304 makes contact with the bumper 343, compressed air starts flowing into the return air chamber 336, and only compressed air existing in the cylinder upper chamber 337 flows into the return air chamber 336.

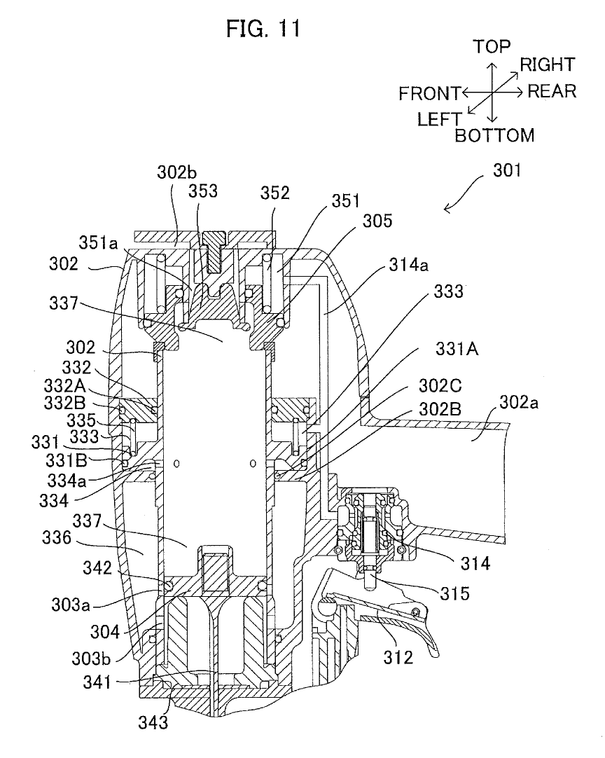

When the operator releases the trigger 312, the plunger 315 returns to the initial position, and compressed air is supplied to the cylinder urging chamber 333 and to the head valve chamber 351 via the control passage 314a. As shown in FIG. 11, this causes the head valve 305 to move downward, and the head valve 305 and the cylinder 303 move downward in an integrated manner. This causes the cylinder 303 to move to the bottom dead center and blocks communication between the cylinder upper chamber 337 and the return air chamber 336. Approximately simultaneously with that, or subsequent to that, the cylinder upper chamber 337 becomes communicated with the air outlet 302b via the air passage 351a, and pressure in the cylinder upper chamber 337 becomes atmospheric pressure. Specifically, the length of the head bumper 353 in the upper-lower direction is slightly shorter than the movement distance of the head valve 305, so that timing at which the cylinder upper chamber 337 becomes communicated with the air outlet 302b is subsequent to, or approximately the same as timing at which communication between the cylinder upper chamber 337 and the return air chamber 336 is blocked. Because pressure in the cylinder upper chamber 337 becomes atmospheric pressure, compressed air accumulated in the return air chamber 336 flows into the cylinder lower chamber 338 via the second air passage 303b. This causes the piston 304 to be pushed upward, and the nail gun 301 becomes the initial state shown in FIG. 7.

In the nail gun 301, in case that compressed air is also filled in the cylinder urging chamber 333 when compressed air is filled in the head valve chamber 351, the cylinder 303 may move to the bottom dead center earlier than the head valve 305 moves downward. Then, because the cylinder 303 is spaced away from the head valve 305 and the cylinder upper chamber 337 is brought into communication with the accumulator chamber 302a, compressed air flows into the cylinder upper chamber 337 and the amount of air consumption increases. In the present embodiment, however, as shown in FIG. 10, when the cylinder 303 is located at the top dead center, the outer circumferential surface 331A partially blocks the opening of the control passage 314a. Hence, even if compressed air flows into the cylinder drive chamber 334 in this state, an abrupt pressure increase can be suppressed. This prevents excess compressed air from flowing into the cylinder upper chamber 337, thereby reducing the amount of air consumption reliably.

With this configuration, when the head valve 305 allows communication between the cylinder upper chamber 337 and the accumulator chamber 302a so that compressed air in the accumulator chamber 302a flows into the cylinder upper chamber 337, the cylinder 303 is located at the bottom dead center and communication between the cylinder upper chamber 337 and the return air chamber 336 is blocked. Hence, compressed air that has flowed into the cylinder upper chamber 337 from the accumulator chamber 302a does not flow into the return air chamber 336. When the piston 304 is in contact with the bumper 343 and the cylinder 303 has moved to the top dead center, compressed air existing in the cylinder upper chamber 337 flows into the return air chamber 336 in a state where communication between the cylinder upper chamber 337 and the accumulator chamber 302a is blocked. Thus, only compressed air existing in the cylinder upper chamber 337 flows into the return air chamber 336, which prevents excess compressed air from flowing into the return air chamber 336 and which can reduce the amount of air consumption. Further, because the cylinder upper chamber 337 does not become communicated with the return air chamber 336 until the piston 304 contacts the bumper 343, a pressure increase in the return air chamber 336 can be prevented while the piston 304 moves downward. Thus, the striking force (driving force) of the nail gun 301 can be increased.

With this configuration, air in the cylinder upper chamber 337 flows into the return air chamber 336 and, after striking (driving) the nail 311, air in the return air chamber 336 flows into the cylinder lower chamber 338. The air which has flowed into the cylinder lower chamber 338 is utilized effectively for returning the piston 304. Thus, the amount of air consumption of the nail gun 301 can be reduced.

With this configuration, the cylinder 303 can be moved with a simple structure.

With this configuration, by adjusting the urging force of the spring 335, time from the operation of the trigger 312 to the movement of the cylinder 303 can be adjusted. Thus, the cylinder 303 can be moved at such timing that the amount of a loss of compressed air is the smallest.

With this configuration, the cylinder urging chamber 333 becomes in communication with the accumulator chamber 302a in conjunction with the operation of the trigger 312. Hence, the operation of the trigger 312 can be linked with the movement of the cylinder 303 with a simple configuration.

With this configuration, when the piston 304 strikes the nail 311 (when the piston 304 makes contact with the bumper 343), the cylinder 303 is brought into blocking the communication between the cylinder upper chamber 337 and the accumulator chamber 302a. Hence, sufficient energy can be supplied to the piston 304 until striking of the nail 311 is finished.

While the invention has been described in detail with reference to the above aspects thereof, it would be apparent to those skilled in the art that various changes and modifications may be made therein without departing from the scope of the claims. For example, in the above-described first through third embodiments, although the head valve located above the cylinder is adopted as an example of the main valve, the main valve may be disposed at a side surface of an upper part of the cylinder.

In the above-described first and second embodiments, after the control passage 14a is communicated with the head valve chamber 51 and the cylinder control chamber 33 so that the head valve 5 causes the cylinder 3 to be communicated with the accumulator chamber 2a, the cylinder 3 moves to the top dead center. However, the invention is not limited to this embodiment. For example, in order that compressed air flows into the cylinder control chamber 33 at more appropriate timing, it may be so configured that the accumulator chamber 2a is communicated with the cylinder control chamber 33, that a valve is provided therebetween, and that an open/close operation of the valve causes the cylinder 3 to move. In this case, it is necessary to newly provide means for discharging compressed air in the cylinder control chamber 33.

In the above-described third embodiment, although the spring 335 is provided in the cylinder urging chamber 333, the spring 335 may be omitted.

1. A fastening tool comprising:
a housing defining a first air chamber for accumulating compressed air;
a trigger provided at the housing;
a cylinder accommodated in the housing;
a piston accommodated in the cylinder and dividing the cylinder into a cylinder upper chamber and a cylinder lower chamber; and
a main valve configured to allow a communication between the cylinder upper chamber and the first air chamber in conjunction with an operation of the trigger,
wherein:
the housing is formed with a second air chamber and a third air chamber;
the second air chamber is communicated with the cylinder upper chamber in conjunction with a movement of the piston, and the third air chamber accumulates or discharges the compressed air in the first air chamber in conjunction with the operation of the trigger; and
the cylinder is movable between a first position where the cylinder upper chamber is in communication with the first air chamber, and a second position where the cylinder upper chamber is blocked from the first air chamber based on a differential pressure between the second air chamber and the third air chamber.

2. The fastening tool according to claim 1, wherein the trigger comprises a trigger valve section for allowing and blocking a communication between the first air chamber and the third air chamber in conjunction with the operation of the trigger, wherein the cylinder moves from the first position to the second position when the trigger valve section blocks the communication between the first air chamber and the third air chamber.

3. The fastening tool according to claim 1, wherein the trigger comprises a trigger valve section for allowing and blocking a communication between the first air chamber and the third air chamber in conjunction with the operation of the trigger, wherein the housing is formed with an air passage having one end opening connected to the third air chamber and another end opening connected to the trigger valve section, the cylinder being configured to block at least part of the one end opening.

4. The fastening tool according to claim 3, wherein the housing defines a fourth air chamber in communication with the third air chamber, the trigger valve section allowing and blocking a communication between the fourth air chamber and the first air chamber, the main valve allowing the communication between the cylinder and the first air chamber based on a pressure of the fourth air chamber.

5. A fastening tool comprising:
a housing defining an accumulator chamber for accumulating compressed air;
a trigger provided at the housing;
a cylinder accommodated in the housing and movable between a first position and a second position;
a piston slidably accommodated in the cylinder in a sliding direction between a top dead center and a bottom dead center, the piston dividing the cylinder into a cylinder upper chamber and a cylinder lower chamber;
a bumper accommodated in the housing, the piston being configured to contact the bumper, the cylinder lower chamber being defined by the bumper, the cylinder, and the piston;
a main valve configured to allow a communication between the cylinder and the accumulator chamber in conjunction with an operation of the trigger; and
a cylinder driving mechanism configured to move the cylinder in the sliding direction,
wherein:
the housing is formed with a return air chamber communicated with the cylinder upper chamber in conjunction with a movement of the piston;
the cylinder driving mechanism comprises a cylinder drive chamber formed at the housing and communicated with the cylinder lower chamber when the piston is positioned at the top dead center;
when the piston moves in the sliding direction so that a communication between the cylinder upper chamber and the cylinder drive chamber is provided, the cylinder moves from the first position to the second position; and
the first position is a position where a communication between the cylinder upper chamber and the return air chamber is blocked, and the second position is a position where the communication between the cylinder upper chamber and the return air chamber is allowable and a communication between the cylinder upper chamber and the accumulator chamber is blocked.

6. The fastening tool according to claim 5, wherein the return air chamber is constantly communicated with the cylinder lower chamber.

7. The fastening tool according to claim 5, wherein the cylinder driving mechanism comprises a cylinder urging chamber formed in the housing and configured to be communicated with the accumulator chamber in conjunction with the operation of the trigger, the cylinder moving from the second position to the first position when the cylinder urging chamber is communicated with the accumulator chamber.

8. The fastening tool according to claim 7, wherein the cylinder urging chamber is provided with an urging member for urging the cylinder from the second position to the first position.

9. The fastening tool according to claim 7, wherein the housing defines a head valve chamber configured to communicate with the accumulator chamber in conjunction with the operation of the trigger, wherein the main valve blocks the communication between the cylinder and the accumulator chamber when the head valve chamber is communicated with the accumulator chamber, the head valve chamber being constantly communicated with the cylinder urging chamber.

10. A fastening tool comprising:
a housing defining an accumulator chamber for accumulating compressed air;
a trigger provided at the housing;
a cylinder accommodated in the housing and movable between a first position and a second position;
a piston slidably movably accommodated in the cylinder in a sliding direction, the piston dividing the cylinder into a cylinder upper chamber and a cylinder lower chamber;
a bumper accommodated in the housing, the piston being configured to contact the bumper, the cylinder lower chamber being defined by the bumper, the cylinder, and the piston;
a main valve configured to allow a communication between the cylinder and the accumulator chamber in conjunction with an operation of the trigger, the cylinder upper chamber being defined by the main valve, the piston, and the cylinder; and
a cylinder driving mechanism configured to move the cylinder in the sliding direction,
wherein:
the housing defines a return air chamber communicated with the cylinder in conjunction with a movement of the piston and accumulating the compressed air which has flowed into the cylinder;
the cylinder driving mechanism moves the cylinder from the first position to the second position after the main valve allow the communication between the cylinder and the accumulator chamber; and
the first position is a position where a communication between the cylinder upper chamber and the return air chamber is blocked, and the second position is a position where the communication between the cylinder upper chamber and the return air chamber is allowable and a communication between the cylinder upper chamber and the accumulator chamber is blocked.

11. The fastening tool according to claim 10, wherein the return air chamber is constantly communicated with the cylinder lower chamber.

12. The fastening tool according to claim 10, wherein the piston is movable between a top dead center and a bottom dead center, wherein the cylinder driving mechanism comprises a cylinder drive chamber formed at the housing and communicated with the cylinder lower chamber when the piston is positioned at the top dead center, the cylinder moving from the first position to the second position when the cylinder upper chamber is communicated with the cylinder drive chamber.

13. The fastening tool according to claim 10, wherein the housing defines a head valve chamber configured to communicate with the accumulator chamber in conjunction with the operation of the trigger, wherein the cylinder driving mechanism comprises a cylinder urging chamber formed in the housing and configured to be communicated with the accumulator chamber in conjunction with the operation of the trigger, the cylinder moving from the second position to the first position when the cylinder urging chamber is communicated with the accumulator chamber.

14. The fastening tool according to claim 13, wherein the cylinder urging chamber is provided with an urging member for urging the cylinder from the second position to the first position.

15. The fastening tool according to claim 14, wherein the main valve blocks the communication between the cylinder and the accumulator chamber when the head valve chamber is communicated with the accumulator chamber, the head valve chamber being constantly communicated with the cylinder urging chamber.
